(19) United States
(12) Patent Application Publication
(10) Pub. No.: US 2007/0032927 A1
(43) Pub. Date: Feb. 8, 2007

(54) Automotive scan tool printer emulation

(75) Inventor: Manokar Chinnadurai, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/196,456

(22) Filed: Aug. 4, 2005

(51) Int. Cl. G01M 17/00

(52) U.S. Cl. 701/29; 701/33

(57) ABSTRACT

A computerized method and product for generating a print out of vehicle data collected by and displayed in an automotive diagnostic tool. The method comprises communicating with the diagnostic tool to receive a first print instruction containing the vehicle data and generating a second print instruction in response. The second print instruction also contains the vehicle data. The method further includes communicating the second print instruction to a printing device to generate a printout of the vehicle data.

### FIELD OF THE INVENTION

The present invention relates generally to automotive diagnostic tool systems. More particularly, the present invention relates to a computerized method and apparatus for printing vehicle data collected and displayed on an automotive diagnostic tool.

### BACKGROUND OF THE INVENTION

Motor vehicles include various electronic control units mounted in the vehicle. The control units may control various systems and/or subsystems within the vehicle. For example, a control unit may control an engine, the transmission, brakes or the steering mechanism. These control units are typically coupled to a variety of sensors and/or actuators.

Handheld diagnostic tools have been utilized to trouble-shoot faults associated with these control units. A typical diagnostic tool, for example, a scan tool, can include a microcontroller and an interface circuit to facilitate communication between the microcontroller and the control units in the vehicle. Each diagnostic tool can also include plug-in module capability to execute and store various diagnostic routines and/or vehicle data to enable the tool to communicate with a vehicle's control unit as well as provide information to a user. The data being stored may include: fault codes that identify problem vehicle components; vehicle system data, for example, power train data, anti-lock breaking system (ABS) data, electrical system data; or sensor data, for example, vehicle temperature, revolutions per minute (rpm) or pressure data.

Generally, the diagnostic or vehicle information can be displayed to the user for analysis in a display panel provided with the diagnostic tool. However, users or technicians of the diagnostic tool often need to print out a hard or paper copy of the displayed data for further analysis, ease of viewing or to provide customers with more complete information regarding the vehicle diagnosis. Diagnostic tools sold to date are sometimes packaged with printers which directly connect to the diagnostic tool to provide a paper printout of the vehicle data report. For example, OTC ACCURACY SERIES BATTERY TESTER, a battery testing device is packaged with a wireless printer. Typically, the provided printer is a custom printer specifically supported by the accompanying diagnostic tool. A problem with such a printer is two-fold: i) the printer is an expense for the manufacturer to provide and ii) the printer is subject to obsolescence for the customer as future diagnostic tools discontinue support of prior custom printers.

One solution to this problem is to provide the diagnostic tool with connectivity capability to a computer processing device, for example, a personal computer (PC) that is in turn, connected to a standard computer printing device, for example, a stand alone laser printer. Software has been developed and packaged for installation on a PC which communicates with the diagnostic tool having stored thereon various vehicle diagnostic data. For example, Service Solutions of SPX Corporation distributes GENESIS CONNECTECH PC SOFTWARE, an automotive diagnostic software for use with a diagnostic tool such as OTC NEXT GENERATION INFORMATION SYSTEM (NGIS) tool. The software provides for the vehicle diagnostic data that has been collected and stored on the diagnostic tool to be downloaded and displayed for playback on a PC. In addition, such software enables a PC to communicate with a diagnostic tool that is simultaneously connected to a vehicle's on-board diagnostic system. Such a configuration provides a user with the capability to run diagnostic routines and display the collected results directly from the PC. Printout of the vehicle data can be provided by executing print commands directly from the PC. A problem with the existing software is that it does not provide a mechanism by which a user can, directly from the diagnostic tool, execute diagnostic routines and execute a command to print to the stand alone printer. This problem presents an inconvenience to the technician using the diagnostic tool that wishes to provide, for example, a printout of a diagnostic data report to a customer but is not directly in front of a connected PC.

Accordingly, a need exists, to provide a computerized method and product which provides for a printout of vehicle data collected on a diagnostic tool in which the printout is generated by a stand alone printer connected to a computer or PC, which is in communication with the diagnostic tool. Moreover, the method and product provide that the print command can be issued directly from the diagnostic tool.

### SUMMARY OF THE INVENTION

The foregoing needs are met, to a great extent, by the present invention, wherein in one aspect a method and product is provided that in some embodiments provides for a printout of vehicle data collected on a diagnostic tool in response to a print command from the diagnostic tool. Moreover. the printout is generated by a stand alone printer connected to a PC which is in communication with the diagnostic tool.

In accordance with one embodiment of the present invention, a computerized method provides a print out of vehicle data collected by and displayed in an automotive diagnostic tool. The method comprises communicating with the diagnostic tool to receive a first print instruction containing the vehicle data. The method further includes generating a second print instruction containing the vehicle data in response to the first print instruction. The method also provides communicating the second print instruction to a printing device to generate a printout of the vehicle data. In another embodiment of the method, the method is performed by a computer processing device coupled to a display device. The method preferably comprises generating an image substantially corresponding to the displayed data of the diagnostic tool in response to the first print instruction, and communicating with the display device to display the image. Preferably, communicating the second print instruction to the printing device is such that the generated printout substantially corresponds to the image of the display device.

Another embodiment of the present invention provides for an automotive diagnostic kit for printing vehicle data. The kit comprises an automotive diagnostic tool for collecting and displaying the vehicle data and a computer readable medium having stored thereon a computer readable program for performing a method. The automotive diagnostic tool can be configured to generate a first print instruction and the method comprises communicating with the diagnostic tool to receive the first print instruction from the diagnostic tool, generating a second print instruction in response to the first print instruction, and communicating the second print instruction to a printing device to generate a printout of the vehicle data. The computer readable program can be preferably configured for installation on a computer processing device to perform at least a portion of the method. In another embodiment, the computer readable program can be configured for installation on the automotive diagnostic tool to couple the tool to a computer to perform the method.

Yet another embodiment of the present invention provides a computer program product for generating a printout of vehicle data collected and displayed by an automotive diagnostic tool. The product preferably comprises a computer readable storage means having computer readable program code means embodied in the storage means for performing a method. The method comprises communicating with the diagnostic tool to receive a first print instruction from the diagnostic tool, generating a second print instruction in response to the first print instruction, and communicating the second print instruction to a printing device so as to generate a printout of the vehicle data. The computer readable storage means can be a CD-ROM, flash drive device, network storage device or any combination thereof.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic illustration of a system configured for performing a method according to a preferred embodiment of the invention.

FIG. 2 is a flow chart showing the steps of a method according to an embodiment of the invention.

FIG. 3 is a block diagram of an automotive diagnostic system according to an embodiment of the invention.

FIG. 4 is a block diagram of an automotive diagnostic system according to another embodiment of the invention.

### DETAILED DESCRIPTION

The invention will now be described with reference to the drawing figures, in which like reference numerals refer to like parts throughout. An embodiment in accordance with the present invention provides a method and apparatus for printing vehicle data stored on and displayed from an automotive scan or diagnostic tool. More specifically, a computerized automotive diagnostic system can be configured to perform a method according to an embodiment of the present invention. The method provides for establishing communication with the diagnostic tool and receiving a first print instruction containing the vehicle data. The method further includes generating a second print instruction in response to the first print instruction and communicating the second print instruction to a printing device for generation of a printout of the vehicle data.

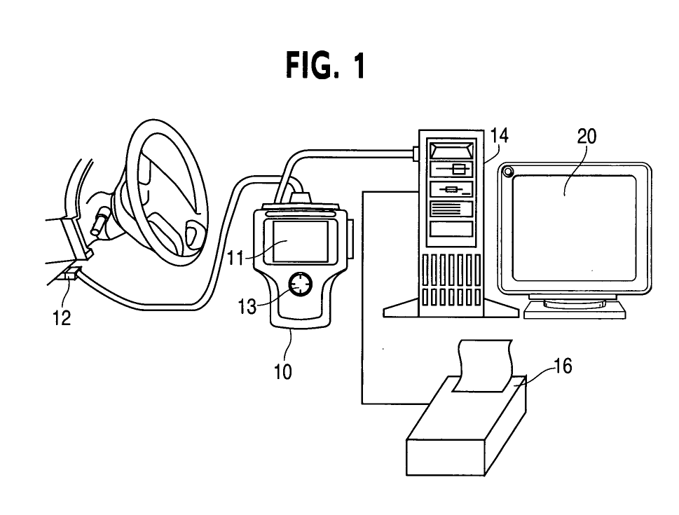

Shown in FIG. 1 is an illustrative automotive diagnostic system configured for performing the method according to an embodiment of the present invention. The system includes an automotive diagnostic tool 10 connected to or in communication with a vehicle on-board diagnostic (OBD) system 12 and a computer processing device 14. Alternatively, the system can be configured with the diagnostic tool 10 coupled to or in communication with the computer processing device 14 and the printer 16 and detached from the OBD system 12. This alternative configuration provides for printout of historical or stored vehicle data on the diagnostic tool 10. Diagnostic tool 10 can include the requisite ports for connection to, a vehicle data link connector or other interface of the OBD system 12. Diagnostic tool 10 can, for example, include a DB-25 pin port, or alternatively a port configured for a J1962 cable connection to a vehicle data link connector. In addition or alternatively to, the diagnostic tool can be configured substantially similarly to, for example, OTC's NGIS automotive diagnostic tool. Diagnostic tool 10 is preferably configured to interface with the OBD system 12 for the purpose of executing various diagnostic routines known in the art and for collecting vehicle data such as, for example, sensor readings or engine performance data such as revolutions per minute (rpm).

Diagnostic tool 10 can also include a display screen or panel 11 to display a lookup table (not shown), or other vehicle data. Display panel 11 can be a VGA, LCD, touch screen or other monitor known in the art. Moreover, display panel 11 can be configured so as to have the facility to present character, numeric and/or graphic information in a manner similar to displays known in the art. Diagnostic tool 10 can also be configured with a user interface 13. More specifically, diagnostic tool 10 can be configured with, for example, buttons or keys to provide for a user interface as is known in the art. The user interface 13 can enable a user to interact and respond to prompts from the various diagnostic routines that can run on diagnostic tool 10. Moreover, the user interface 13 can enable navigation of lookup tables presented in display 11. Alternatively or in addition to, diagnostic tool 10 can include a graphical user interface configured for presentation in display panel 11 where, for example, display panel 11 is configured as a touch screen known in the art.

Diagnostic tool 10 is also configured to interface with the computer processing device 14. More specifically, computer processing device 14 can be a stand alone device such as, for example, a personal computer (PC) or MACINTOSH computer configured as a desktop or laptop. Alternatively, the computer processing device 14 can be configured for connection to a network such as, for example, a LAN, WAN or the Internet. The computer processing device 14 can include a display device or monitor 20 capable of displaying text and graphics. Accordingly, display 20 can display an image substantially corresponding to or emulating the vehicle data displayed in the diagnostic tool 10. The display device 20 can be a CRT or flat panel, VGA, LCD, touch screen or any other computer display monitor as is known in the art.

The computer processing device 14 is preferably capable of connection to and communication with a printing device 16. The printing device 16 can be any commercially available computer printer such as, for example, a laser printer, inkjet printer, dot matrix or other printer known in the art. In addition, the printing device 16 is configured for connection to and communication with the computer processing device 14 by way of printer drivers that are fully supported by commercially available operating systems such as, for example, WINDOWS, LINUX or MAC operating systems.

With the diagnostic tool 10 connected in an automotive diagnostic system as described, a user can utilize the user interface 13 of diagnostic tool 10 to execute a diagnostic routine and collect a set of vehicle data for display on the panel 11 of diagnostic tool 10. The interface 13 of diagnostic tool 10 can be further configured to include a touch button, soft-key, drop down selection menu, voice recognition or other user interface known in the art to execute a print command from tool 10. Using such an interface 13, the user can send a print command or instruction to the computer 14. In response, computer 14, being coupled to or in communication with printer 16, can convey a print instruction to printer 16 to provide a printout of the vehicle data. Preferably, the printout substantially corresponds to the vehicle data shown on diagnostic tool 10.

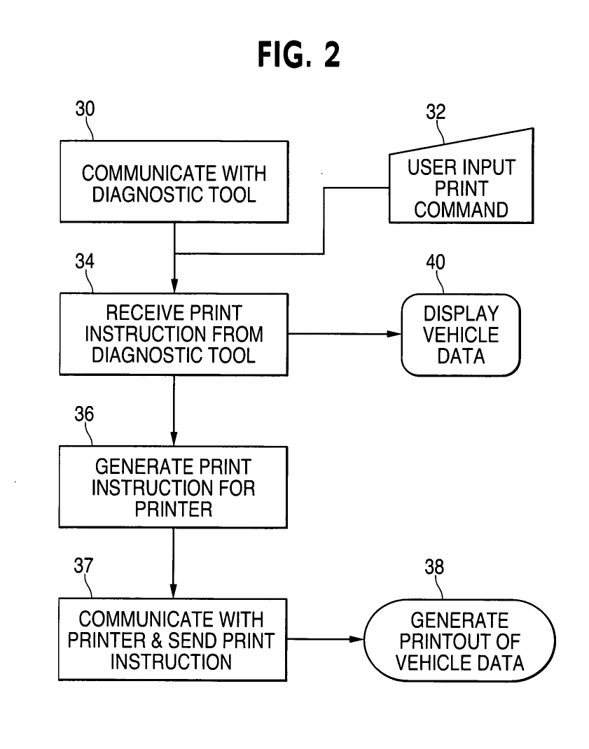

FIG. 2 illustrates a flow chart of a method according to an embodiment of the present invention. Upon connection to an automotive diagnostic system as previously described, the computer 14 can perform a communication step 30 and establish communication with the diagnostic tool 10. Alternatively, diagnostic tool 10 can establish the communication between the diagnostic tool 10 and the computer 14. With the communication established, computer 14 can perform a receiving step 34 to receive a print instruction from the diagnostic tool 10.

The print instruction from diagnostic tool 10 can include specific vehicle data to be printed, for example, vehicle data corresponding to the current display in diagnostic tool 10. In addition, the print instruction can include format specifications to tailor the appearance of the print out or the print instruction can include any other data either requested by the user or provided by default, for example, time and date stamp of vehicle data. The print instruction from diagnostic tool 10 can be generated automatically. For example, the diagnostic tool 10 can include a diagnostic routine that is configured to run a diagnostic test, collect data and display the data to the user. Upon display of the data, the diagnostic routine automatically generates a print command to issue from diagnostic tool 10. Alternatively, the print instruction can be generated by a user of diagnostic tool 10, using the interface 13. The user can, for example, depresses or select a button, key or drop down menu of interface 13 to issue a command to print. Accordingly, shown in FIG. 2 is user input 32 for generation of a print instruction to be received by computer 14 in receiving step 34.

Further according to the method, the computer 14 can perform a generation step 36 to generate a second or subsequent print instruction. The generated print instruction can contain the vehicle data displayed by diagnostic tool 10 and print specifications, for example, format or layout specifications or any other printing instruction communicated from diagnostic tool 10. More specifically, where computer 14 includes a printer driver for communication with a printer 16, the generation step 36 can simply provide for the appropriate control commands from the printer driver to the printing device 16 for printing out the vehicle data. Alternatively, the generation step 36 can generate a print instruction including default or custom printing format instructions that were not originally provided by diagnostic tool 10. The generation step 36 can be in immediate response to the user input step 32 or alternatively the generation step 36 can be an automated response to any other communication from diagnostic tool 10.

In a communication step 37 between the computer 14 and the printer 16, the computer 14 can communicate to the printer 16 the generated print instruction of the generation step 36. In response to the communicated print instruction, a properly configured printer 16 can perform print generation step 38 to generate a printout that corresponds to the second print instruction. Preferably, the printout substantially corresponds or complies with the print instruction from the diagnostic tool 10. The printout can, for example, substantially correspond to the vehicle data shown in the display window of diagnostic tool 10.

In another embodiment of the method, the computer can perform a display step 40 shown in FIG. 2. The computer 14 can be configured for communication with a display device, for example, the display 20. Following the receipt step 34 of a print instruction from diagnostic tool 10, computer 14 can communicate with the display 20 to perform display step 40 and display the vehicle data. Alternatively, the display step 40 can be performed as an automatic response to communication step 30. The display step 40 can also be configured such that the vehicle data displayed substantially corresponds to or emulates the vehicle data shown on diagnostic tool 10 and can serve as the print instruction in the generation step 36 such that the printout substantially corresponds to the image of display 20.

The method according to the present invention can be embodied in a software program that is configured for installation and execution on a computer processing device 14. Alternatively, the software program can be installed for execution on a diagnostic tool 10 that is coupled to a computer 14 and printer 16. The software program can be more specifically embodied and stored on a computer readable storage device or medium, such as for example, a CD-ROM, flash drive, a server connected to a network such as the Internet or any other computer readable medium known in the art. In a kit according to one embodiment of the present invention a diagnostic tool 10 can be packaged with a computer readable medium as described. The medium can be configured so as to have stored on it a computer readable program for performing the method for printing the vehicle data in accordance with the method previously described. The medium can be coupled to a computer 14 configured for connection to diagnostic tool 10 and a printer 16. The program can then be installed on the computer 14 such that the program embodying the method can be executed. Alternatively, the program can run on the computer readable medium without being loaded onto the diagnostic tool 10 or the computer 14 as discussed below.

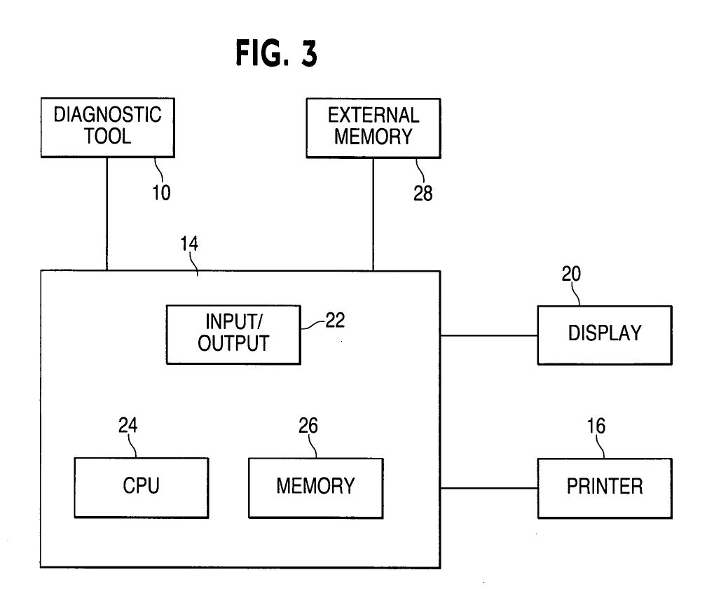

Shown in FIG. 3 is a block diagram of an automotive diagnostic system and its functional elements configured in accordance with an aspect of the present invention. Shown schematically is the diagnostic tool 10 connected and in communication with the computer processing device or computer 14. Connectivity between the diagnostic tool 10 and the computer 14 can be established by way of communications ports resident on the tool 10 and the computer 14, for example, each of the devices 10, 14 can include a serial port such as a RS-232 serial port for RS-232 cable connection. Alternatively, the diagnostic tool 10 and computer 14 can be configured with a port for a USB cable connection, fire wire cable connection, IEEE 1394 connection or any other cable connection known in the art. Moreover, diagnostic tool 10 and computer 14 can be configured for networked communication using appropriately configured standard Personal Computer Memory Card International Association (PCMCIA) ports on each device. In addition, diagnostic tool 10 and computer 14 can be configured for wireless communication using wireless network connections, IR or IRDA connection or other wireless connections known in the art.

Input/output module 22 is schematically shown and is to be understood to include devices such as for example, keyboards, communication ports and associated drivers for communication with peripheral devices such as the printer 16, the display 20, the external memory 28 and the diagnostic tool 10. The computer 14 can be configured with an appropriate number of drivers, ports and/or connectors for connection to, for example, the display device 20 and printing device 16. More specifically, the computer 14 can be connected to the printer 16 and/or display device 20 by a way of a serial cable connection, USB cable connection, fire wire cable connection, network connection, wireless connection or any other connection known in the art for connecting the computer 14 to an external output device.

The computer 14 also preferably includes a central processing unit (CPU) 24 for execution of software programs and the read/write of data. For example, the CPU 24 can be configured for execution of a printer emulation software program embodying a method according to the present invention as described above. More specifically, the CPU 24 can be coupled to an internal memory 26 and/or an external memory 28 on which the software program can be stored. The memory 26, 28 can be configured to store diagnostic software or routines and/or user data for updating and communicating with diagnostic tool 10. Moreover, external memory 28 can be CD-ROM, flash drive devices or any other external memory storage device known in the art.

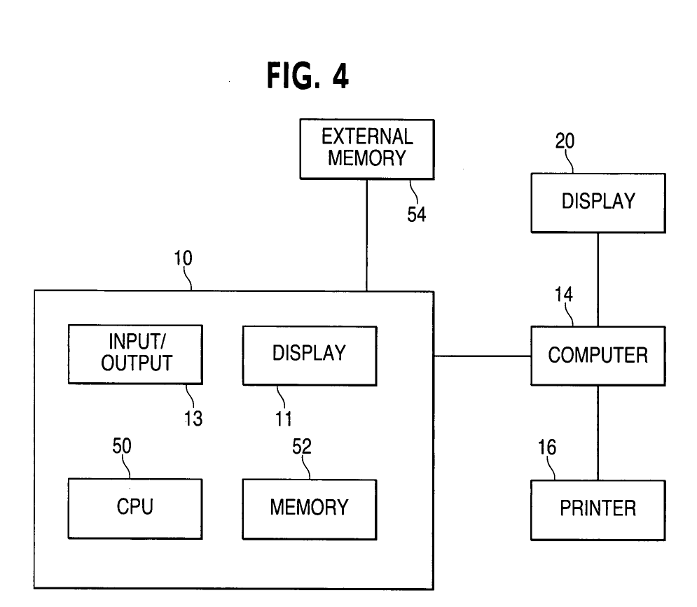

Alternatively, the program can be configured for installation and execution on diagnostic tool 10. Shown in FIG. 4 is a block diagram of a diagnostic tool 10 in an automotive diagnostic system according to another embodiment of the present invention. Diagnostic tool 10 can include a processor 50 in communication with an internal memory 52 and/or an external memory 54. The internal memory 52 can provide for boot code, an operating system, and/or diagnostic applications. External memory 54 can provide for storage of diagnostic routines, data or other diagnostic programs. External memory 54 can be CD-ROM, flash drive devices or any other external memory storage device known in the art. The processor 50 can communicate with the memory 52, 54 for the execution of the variously stored programs. The processor 50 can further communicate with interface 13 and display panel 11 for user interface and display functions as previously described.

A software program embodying a method according to embodiment of the present invention can be stored on external memory 54 or alternatively on internal memory 52 for execution and operation on diagnostic tool 10. Accordingly, the tool can establish communication between the diagnostic tool 10 and the computer 14. With communication established, the method can proceed as previously discussed. Execution of the program occurs over the communication link between the diagnostic tool 10 and the computer 14. Such a communication link can be, as described above, cable connection, network communication or wireless. Connections between the computer 14, the printer 16, and/or the display 20 can be configured as previously discussed.

Alternatively, the software program embodying the method of the present invention can be embodied on a storage device or medium as a computer product independent of a diagnostic tool 10. A user can couple the medium to a computer 14 to access the computer program and install the program on the computer processing device 14 or diagnostic tool 10. Alternatively, the program can be accessed by the computer 14 or diagnostic tool 10 so as to run the program on the medium without installation on either of the computer processing device 14 or the diagnostic tool 10. The computer program can be further configured so as to provide or update the diagnostic tool 10 with a user interface 13 capable of issuing a print command. For example, the computer program can install a print menu for display on display panel 11 of diagnostic tool 10. The print menu can be configured by navigation by interface 13. Such techniques for updating or remotely updating a diagnostic tool 10 coupled to computer 14 is known in the art.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computerized method of generating a print out of vehicle data collected by and displayed in an automotive diagnostic tool, the method comprising:
communicating with the diagnostic tool so as to receive a first print instruction from the diagnostic tool, the first print instruction containing the vehicle data;
generating a second print instruction in response to the first print instruction, the second print instruction containing the vehicle data; and
communicating the second print instruction to a printing device so as to generate a printout of the vehicle data.

2. The computerized method of claim 1, wherein the method is performed by a computer processing device in communication with a display device, the method further comprising generating an image substantially corresponding to the displayed data of the diagnostic tool in response to the first print instruction; and
communicating with the display device to display the image.

3. The computerized method of claim 2, wherein the communicating the second print instruction to the printing device is such that the generated printout substantially corresponds to the image of the display device.

4. The computerized method of claim 1, wherein at least one of communicating with the diagnostic tool and communicating with the printing device is configured for a wireless communication.

5. The computerized method of claim 1, wherein the communicating with the diagnostic tool includes receiving a user input entered into the diagnostic tool, the user input having a command to print.

6. The computerized method of claim 5, wherein the generating a second print instruction is configured to be performed in direct response to the receiving the user input.

7. The computerized method of claim 1, further comprising providing the diagnostic tool with a user interface configured to receive a user input so as to generate the first print instruction, and wherein the generating the second print instruction is configured to be performed in response to the user interface receiving the user input.

8. An automotive diagnostic kit for printing vehicle data comprising:
an automotive diagnostic tool for collecting and displaying the vehicle data, the automotive diagnostic tool being configured to generate a first print instruction having the vehicle data; and
a computer readable medium having stored thereon a computer readable program for performing a method comprising:
communicating with the diagnostic tool so as to receive the first print instruction from the diagnostic tool;
generating a second print instruction in response to the first print instruction, the second print instruction containing the vehicle data; and
communicating the second print instruction to a printing device so as to generate a printout of the vehicle data.

9. The kit of claim 8, wherein the automotive diagnostic tool includes a user interface configured to receive a user input, the automotive diagnostic tool being configured to generate the first print instruction in response to the user interface receiving the user input.

10. The kit of claim 8, wherein the method further comprises generating an image substantially corresponding to the displayed data of the diagnostic tool in response to the first print instruction; and
communicating with a display device to display the image.

11. The kit of claim 10, wherein communicating the second print instruction to the printing device is such that the generated printout substantially corresponds to the image of the display device.

12. The kit of claim 8, wherein the computer readable program is configured for installation on a computer processing device so as to perform at least a portion of the method.

13. The kit of claim 12, wherein the automotive diagnostic tool is configured for simultaneous connection to the computer processing device and a vehicle diagnostic system to collect the vehicle data and communicate with the computer processing device to perform the method.

14. The kit of claim 8, wherein the storage medium includes a CD-ROM, a flash drive device, networked device or any combination thereof.

15. The kit of claim 8, wherein the computer readable program is configured for installation on the automotive diagnostic tool for coupling the tool to a computer so as to perform the method.

16. A computer program product for generating a printout of vehicle data collected and displayed by an automotive diagnostic tool, the product comprising:
computer readable storage means having computer readable program code means embodied in the storage means for performing a method comprising:
communicating with the diagnostic tool so as to receive a first print instruction from the diagnostic tool, the first print instruction containing the vehicle data;
generating a second print instruction in response to the first print instruction, the second print instruction containing the vehicle data; and
communicating the second print instruction to a printing device so as to generate a printout of the vehicle data.

17. The computer program product of claim 16, wherein the computer readable storage means is coupled to a computer processing device such that the computer processing device can perform the method.

18. The computer program product of claim 16, wherein the storage means is coupled to the automotive diagnostic tool, the diagnostic tool being coupled to a computer processing device such that the computer processing device can perform the method.

19. The computer program product of claim 16, wherein the computer readable storage means is a CD-ROM, flash drive device, network storage device or any combination thereof.

20. The computer program product of claim 16, wherein the method further comprises providing the diagnostic tool with a user interface configured to receive a user input for generating the first print instruction, and wherein further the generating the second print instruction is configured to be performed in response to the user interface receiving the user input.
